(19) United States
(12) Patent Application Publication
(10) Pub. No.: US 2010/0155428 A1
(43) Pub. Date: Jun. 24, 2010

(54) Mounting Device

(75) Inventors: Chris Efstathios Housmekerides, Wassenaar (NL); Karl Ludwig Gibis, Limburgerhof (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser NV, Hoofddorp (NL)

(21) Appl. No.: 12/447,353

(22) PCT Filed: Oct. 29, 2007
(86) PCT No.: PCT/GB07/04119

§ 371 Date: Feb. 8, 2010

(30) Foreign Application Priority Data
Oct. 30, 2006 (GB) 0621569.3

(51) Int. Cl. B67D 7/06

(52) U.S. Cl. 222/185.1

(57) ABSTRACT

The invention relates to a mounting device, particularly arranged for mounting a detergent delivery cartridge (100) to an interior of a dishwasher. The mounting device comprises a mounting clip (200) and a slider mechanism, whereby the slider mechanism forms part of a detergent delivery cartridge, and the mounting clip (200) is positively locatable into one of a plurality of locations along said slider mechanism to provide a height adjustable mounting.

The invention relates to a mounting device, particularly but not exclusively arranged for mounting a delivery cartridge comprising a plurality of unit dose elements of a soluble or dispersible detergent composition securely onto an interior part of a machine dishwasher.

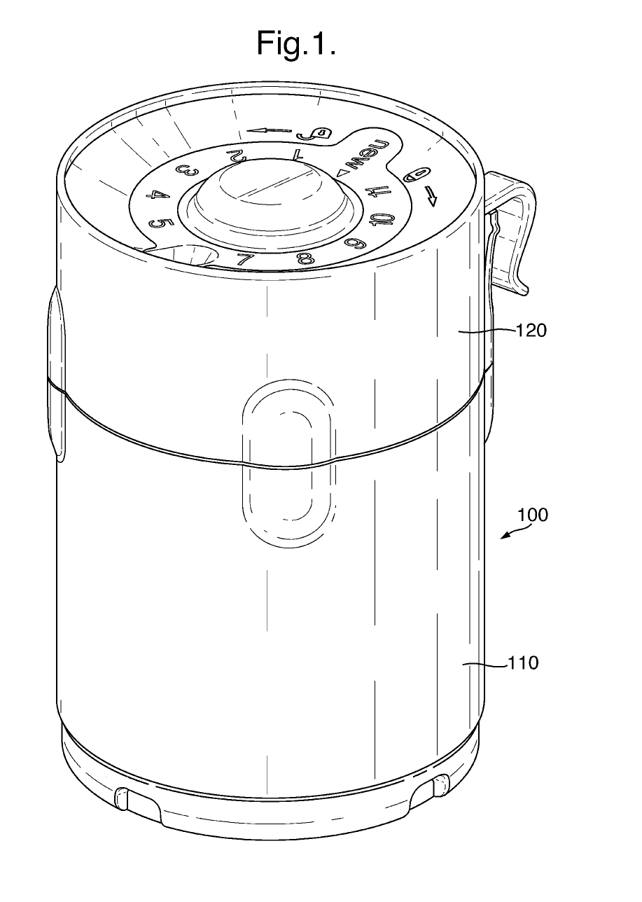

FIG. 1 shows a delivery cartridge susceptible for use with a mounting device in accordance with the present invention. The delivery cartridge 100 comprises a lower receptacle 110, and a lid 120 for cooperation with the lower receptacle 110. The cartridge 100 is arranged to receive a plurality of sticks of detergent composition for carrying out an equal plurality of dishwashing cycles. In the example shown, there is provision for twelve dishwashing cycles to be carried out before the delivery cartridge needs to be refilled.

The subject of the present invention is a mounting device, or clip, for ensuring secure mounting of the delivery cartridge to an interior part of a machine dishwasher.

There are various problems which need to be overcome in providing a suitable mounting device.

Firstly, it will be appreciated that there are many different types of machine dishwasher on the market and, whilst these share certain common elements, the actual design of dishwashers varies considerably in terms of the heights, widths etc of the interior wire baskets or tracks that receive the dirty dishes, cutlery etc. In particular dishwasher racks in the United States differ significantly from European ones. The delivery cartridge needs to be fixed to the rack of the dishwasher to ensure that it stands upright (perpendicular) to allow the water catchment area at the top of the cartridge to collect as much water as possible and needs to be fixed so that it will not fall on its side when the rack is moved in and out by the consumer. Further, whilst it is often desirable to fix the delivery cartridge to the highest horizontal wire of the rack, sometimes dishwasher dimensions are such that the top of the delivery cartridge would collide with the roof of the dishwasher tub when the rack is moved in—therefore, positioning in this way is not always possible. There is also often a large variation in wire thickness between different types of dishwashers and the thickness could, for instance, vary from between 3.5 to 7 mm in diameter. With this design variation in mind, there is a need for a clip which will fit all of the generally available dishwashing machines and which will allow secure placement of the delivery cartridge 100 in a suitable location within the dishwasher. By a suitable location, it is preferred that the delivery cartridge 100 should be placed on an upper level rack of a dishwasher in an area in which there is likely to be good possibilities for the collection of water by the delivery cartridge from the dishwasher spray nozzles. Also, because of requirements regarding detergent dispersal for the sticks of detergent within the delivery cartridge 100, there is a requirement for the cartridge to be placed in a substantially vertical orientation so as to maximise efficiency of the device.

Furthermore, it will be appreciated that occasionally stacking of dishwashers by users is not completely efficient and that articles can move around during the filling of the dishwashing racks, when the door of the dishwasher is closed, and also during washing cycles should crockery shift, for instance, whilst a wash is taking place.

With all of the above in mind, it is an aim of preferred embodiments of the present invention to provide a mounting device capable of fixing a delivery cartridge in a sturdy fashion to a wide range of types of a dishwasher rack, with wire thicknesses ranging from approximately 3 to 7 mm diameter. It is also an aim of preferred embodiments of the present invention to provide a mounting device capable of mounting a delivery cartridge to horizontal rack wires having various different vertical height positions and it is further desirable to provide a mounting device capable of being fixed to points where horizontal and vertical wires cross within a dishwasher rack.

In accordance with the above, it is a general aim of preferred embodiments of the invention to provide a mounting device for use with a dishwashing detergent composition delivery cartridge that is capable of coping with the above situations and of mounting and maintaining such a cartridge securely and in a required orientation.

According to an aspect of the invention, there is provided a mounting device comprising a mounting clip and a slider mechanism, whereby the slider mechanism forms part of a detergent delivery cartridge and the mounting clip is positively locatable into one of a plurality of locations along said slider mechanism to provide a height adjustable mounting for attaching a detergent delivery cartridge to an interior part of a machine dishwasher.

Preferably, said slider mechanism extends substantially vertically and is formed to one vertical side of the detergent delivery cartridge.

The mounting clip is most preferably arranged to positively locate the detergent delivery cartridge to a rack or basket of a machine dishwasher.

Suitably, the slider mechanism may comprise a linearly extending ratchet base, having a plurality of detent positions defined by a plurality of ridges formed at regularly spaced intervals along at least part of its length and includes at least one vertically extending guide portion for guiding movement of the mounting clip thereon.

The mounting clip preferably includes guide means for cooperation with said at least one guide portion of the slider mechanism and comprises detent means for cooperation with the ridges of said slider mechanism to enable said mounting clip to be positively located in one of a plurality of possible mounting positions along said slider mechanism.

Preferably, the mounting clip comprises retaining means for positively locating the mounting clip to the interior part of the dishwasher and preferably comprises at least one retaining finger depending outwardly from a body portion of the mounting clip and arranged for positive association with said interior part of said dishwasher.

Said retaining means preferably comprises at least two retaining fingers and, said retaining fingers are spaced apart from one another in the horizontal direction, so as to allow a vertical member of a dishwasher rack to run between them.

The mounting device preferably further comprises biasing means for providing said positive association and said biasing means and said retaining means are arranged to grip said interior part between them.

Said at least one retaining finger may comprise a reflex portion curved away from a main body part of the mounting clip so as to allow easy admission of said interior part.

Preferably, said reflex portion and said biasing means between them form a jaw area, into a widest part of which the interior part is introducible and progressively moveable into a constricted area.

Preferably, said interior part of the machine dishwasher is positively gripped between said biasing means and retaining means in the constricted area defined between said retaining means and biasing means.

Said biasing means may comprise at least one arm extending from a body portion of the mounting clip.

The biasing means preferably extends intermediate said at least one retaining finger and said slider mechanism.

Preferably, said biasing means includes a ramped area which is arranged to guide said interior part along its ramped surface.

Said biasing means may include a retaining area, against which, in use, said interior part is arranged to abut.

Said mounting clip is preferably formed from a single plastics moulding.

Alternatively, said biasing means may comprise a metal clip forming at least one biasing arm.

Said metal clip may comprise a C-shaped metal clip, wherein the arms of said C-shape perform a biasing function, whilst a stem portion of said C-shape forms a locating part for cooperation with a main body portion of the mounting clip, wherein said arm or arms is/are positively biased toward an interior surface of the retaining means.

Said retaining means may comprise at least one retaining finger including a hook portion, wherein said hook is directed toward a main body portion of said mounting clip.

Said biasing means is preferably arranged to clamp said interior part between the biasing means and said hook portion.

In another aspect there is provided a delivery cartridge for delivering dosages of detergent composition to a dishwasher, said cartridge including a mounting device according to the first aspect.

For a better understanding of the invention, and to show how embodiments of the same may be carried into effect, reference will now be made, by way of example, to the accompanying diagrammatic drawings in which:

FIG. 1 is a perspective view of a delivery cartridge incorporating a mounting device according to first embodiment of the invention;

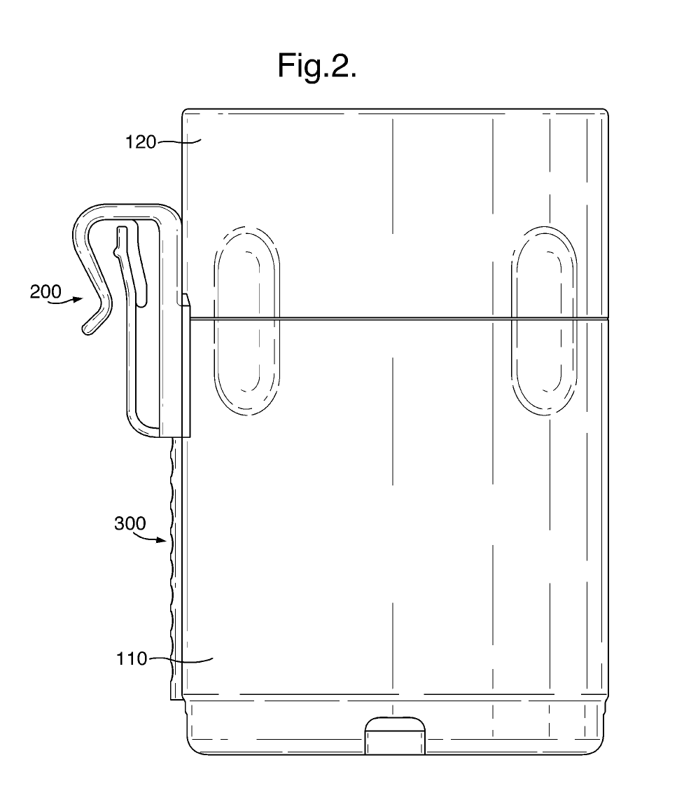

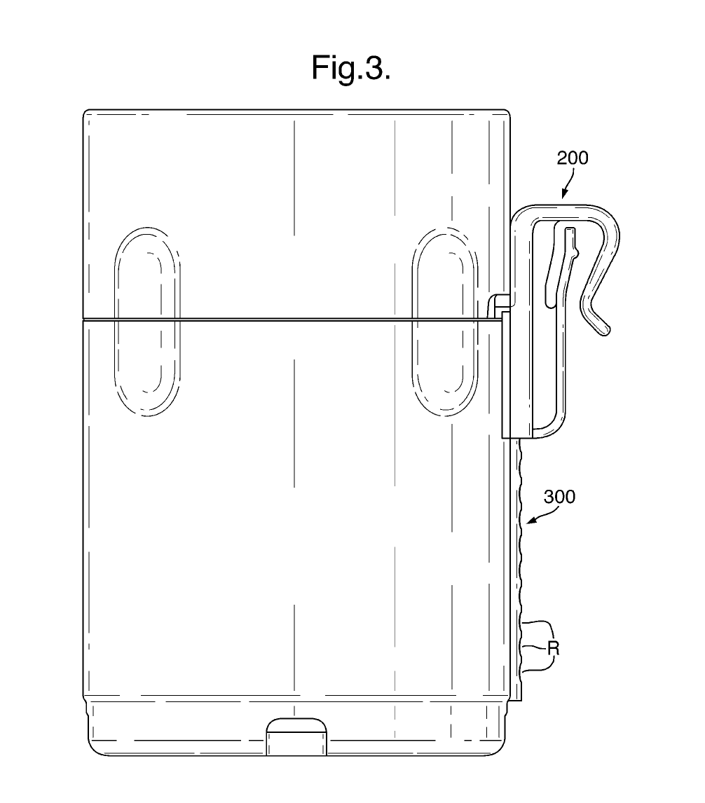

FIGS. 2 and 3 show opposite side profiles of the mounting clip and delivery cartridge of FIG. 1;

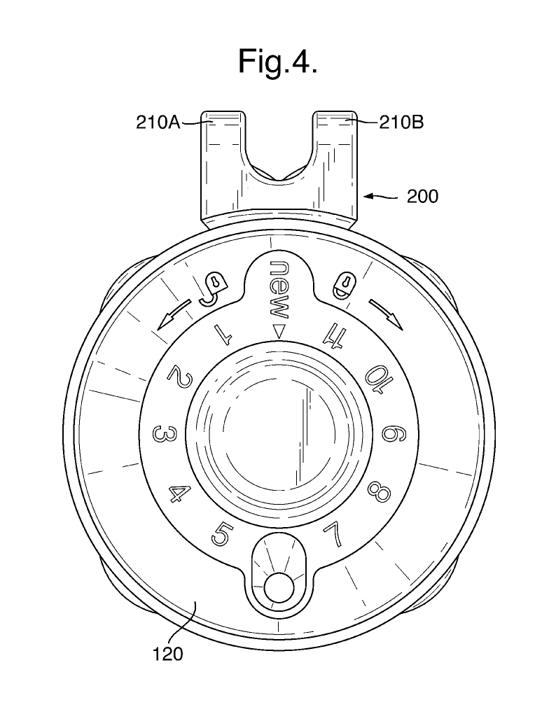

FIG. 4 is a top plan view of the delivery cartridge and mounting clip of FIGS. 1 to 3;

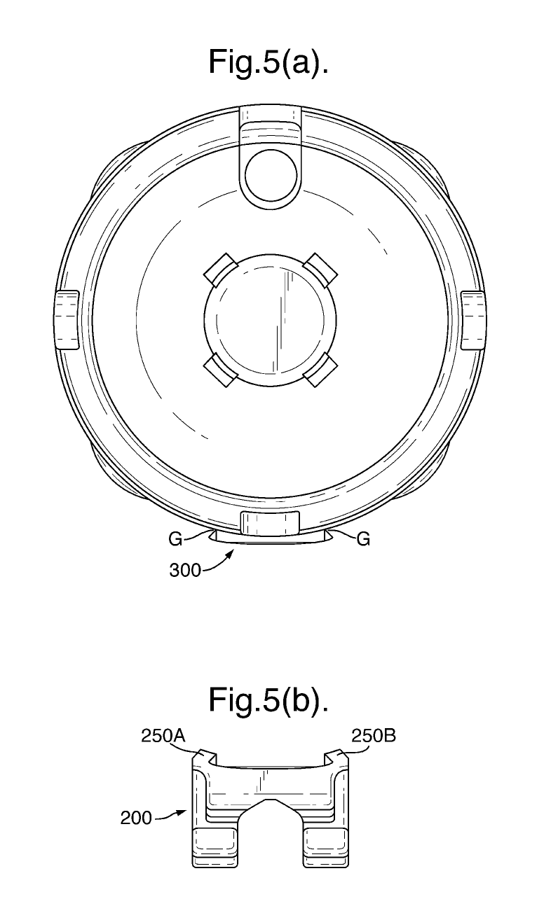

FIGS. 5(a) and 5(b) show respectively a bottom plan view of the delivery cartridge and the mounting clip of FIGS. 1 to 4;

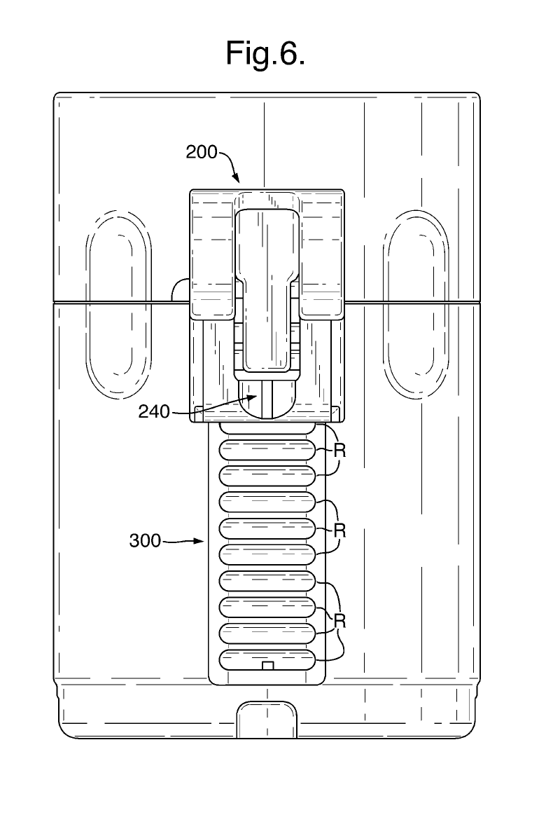

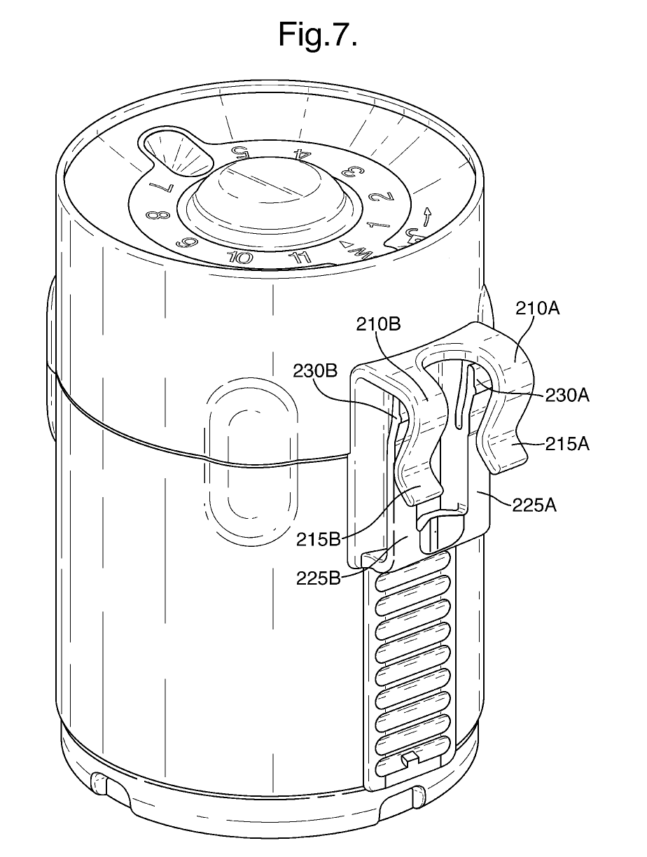

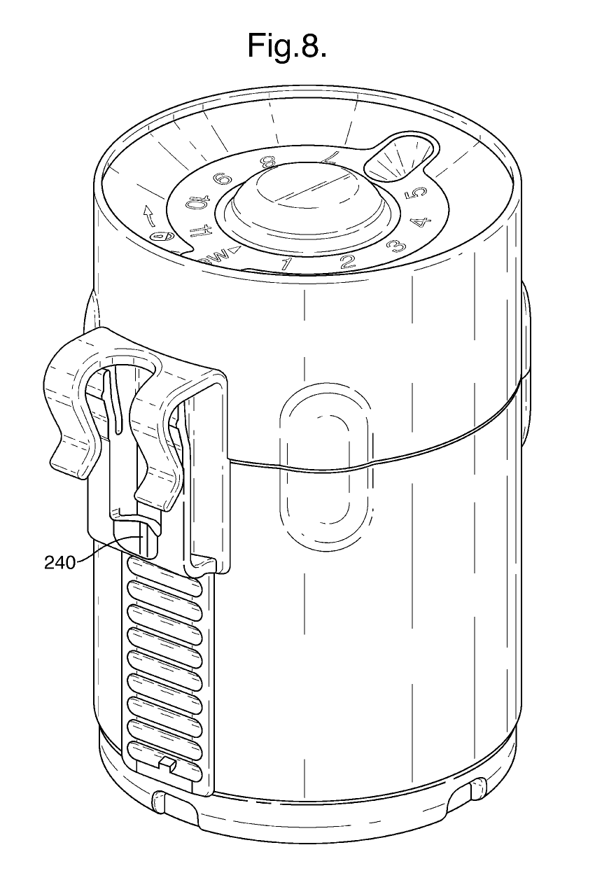

FIGS. 6, 7 and 8 show, in greater detail the mounting device of the first embodiment and in particular the relation between the mounting clip and a slider mechanism formed on the delivery cartridge;

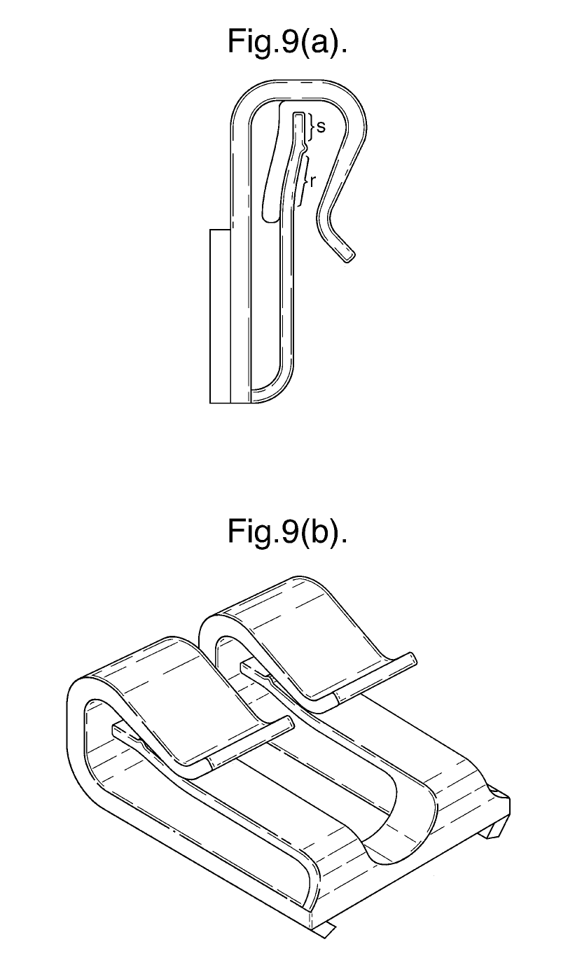

FIGS. 9(a) and 9(b) show a variation of the clip of the first embodiment in side and perspective view respectively;

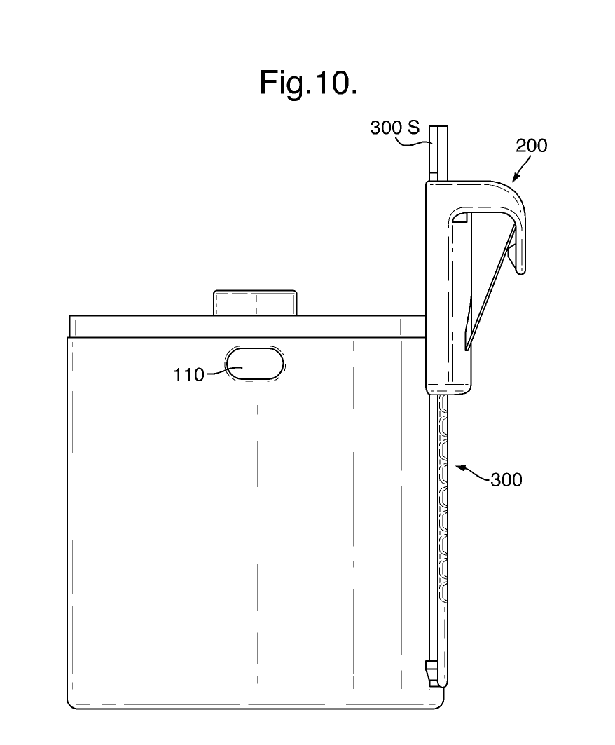

FIG. 10 shows a second embodiment of the mounting clip in cooperation with the lower receptacle of a delivery cartridge;

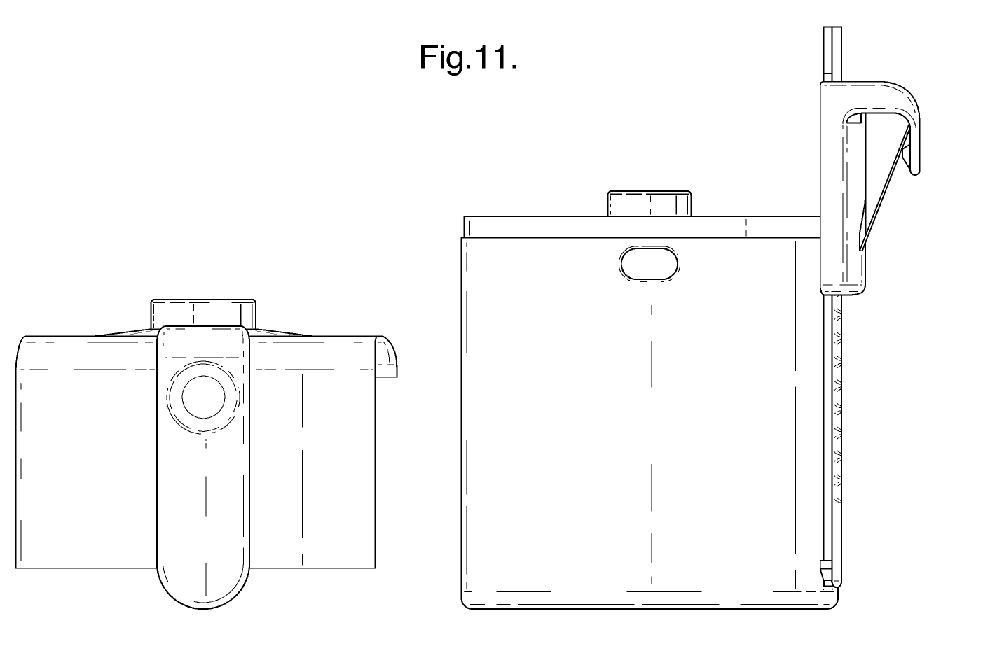

FIG. 11 shows the mounting device and delivery cartridge of the second embodiment, with the lid portion of the delivery cartridge placed to one side;

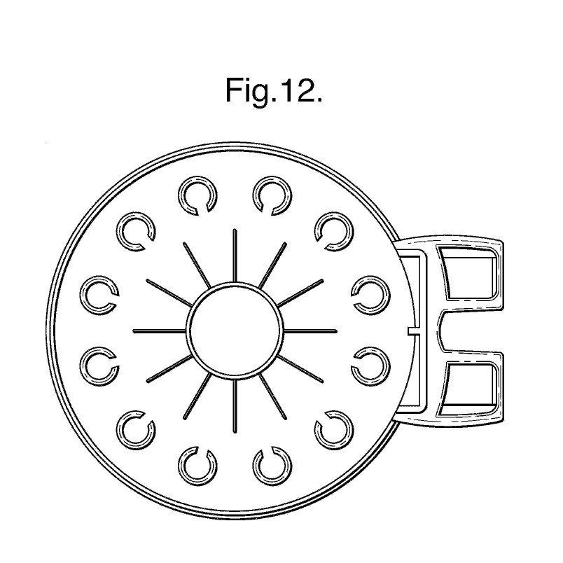

FIG. 12 is a top perspective view of the mounting device of the second embodiment in cooperation with the lower receptacle of the delivery cartridge;

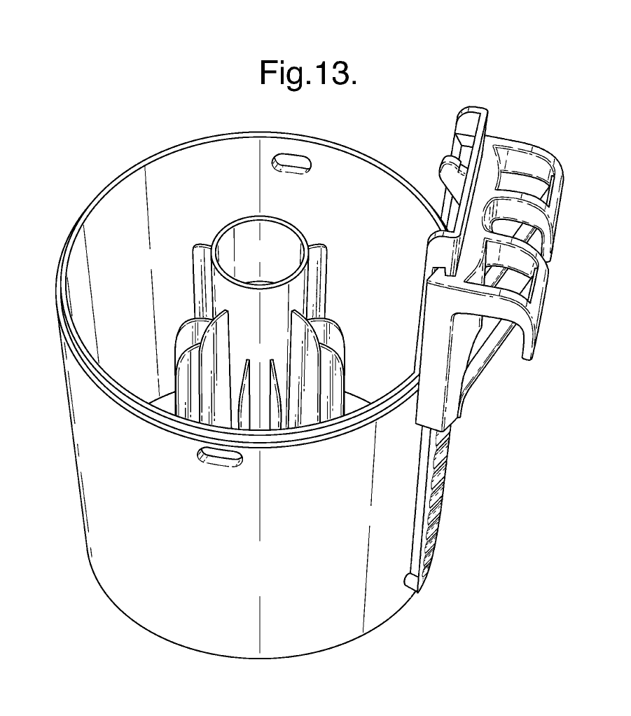

FIG. 13 is a perspective view from above and to one side showing the mounting device and delivery cartridge lower receptacle of the second embodiment;

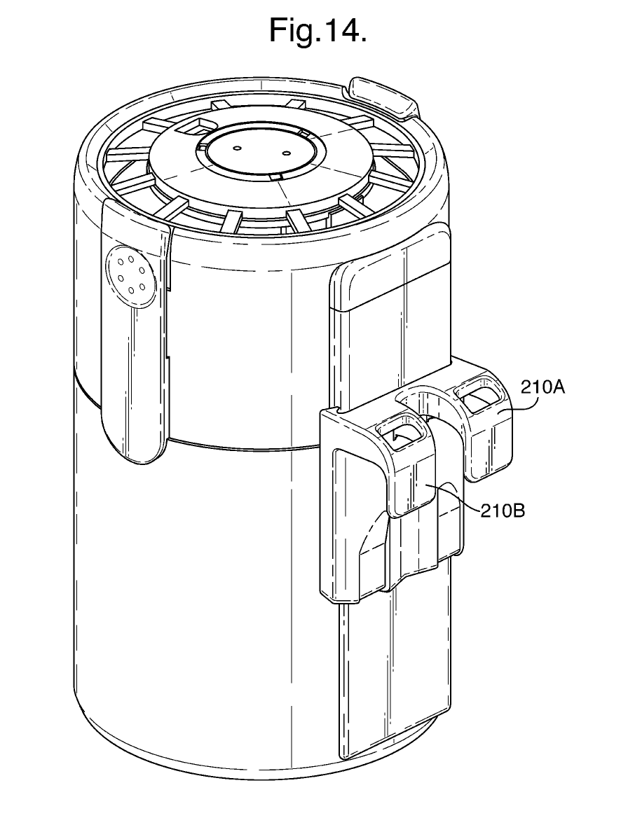

FIG. 14 is a perspective view showing a delivery cartridge and a variation upon the second embodiment of mounting device; and

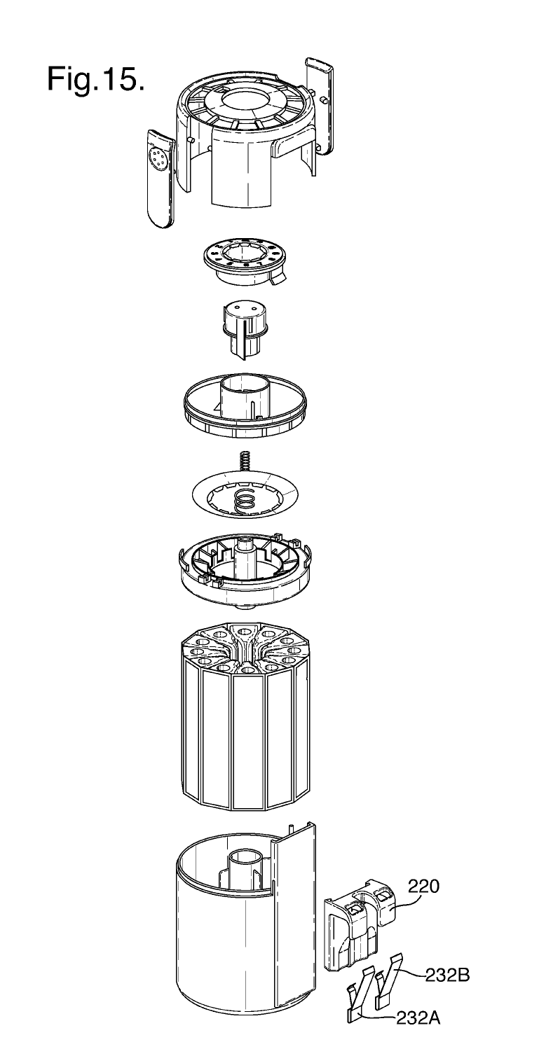

FIG. 15 is an exploded view of the delivery cartridge and mounting device of FIG. 14.

Referring now to FIGS. 1 through 8, a first embodiment of a mounting device for use with a delivery cartridge 100 for delivering dosages of detergent to a dishwasher will now be described.

The mounting device comprises a mounting clip 200 cooperating with a slider mechanism 300 formed on the lower receptacle 110. The slider mechanism 300 acts as a linearly extending ratchet base, having a number of detent positions defined by a plurality of ridges R formed at regularly vertically spaced intervals along its length. This slider mechanism 300 extends vertically upwardly and is formed on one side of the lower receptacle 110. Further, the slider mechanism 300, as can best be seen from FIG. 5(a), (which shows the slider mechanism 300 separated from this mounting clip 200), is profiled so as to include vertically extending guide portions G, for retaining the clip 200 thereon, and constrain movement of the clip 200 to the vertical path defined by the slider mechanism 300. At an upper most portion of the slider mechanism 300, there is also preferably formed an end stop (not shown) so as to prevent movement of the mounting clip 200 beyond an upper most extent of the pathway defined by the sliding mechanism 300 upon which the mounting clip 200 is positionable.

The mounting clip 200 comprises a pair of retaining fingers 210a, 210b depending outwardly from a body portion 220, biasing means 230a, 230b also extending from the body portion 220, detent means 240 for cooperating with the ridges R of the ratchet member 300 and transversely disposed guide means 250a, 250b for cooperating with the guide portions G of the ratchet member 300.

The construction and use of the mounting device comprising clip 200 and slider mechanism 300 will now be described in more detail.

As has been already described, the slider mechanism 300 is formed so as to have regularly spaced ridges R, along its vertical extent and to have guide portions G at its transverse edges so as to make a ratchet base along which the mounting clip 200 may be positively located in one of a plurality of possible mounting positions. The mounting clip 200 may be associated with the ratchet member 300, at a factory (or subsequently) by engaging the guide means 250a, 250b of the clip 200 into the guide portions G at the lower most extent of the slider mechanism 300 and sliding the mounting clip 200 along the slider mechanism 300 to a desired vertical position. As the clip 200 is moved along the ratchet member 300, the detent means 240, which is resiliently formed so as to be capable of a certain degree of flexing, moves along the ratchet member such that, as each time it encounters a ridge, the detent means 240 may be flexed outwardly to force the clip 200 over the next vertical ridge and into a given detent position. This sliding/forcing action may be used so as to bring the mounting clip 200 to any particular desired position along the slider mechanism 300, with the detent means 240 sitting in grooves between ridges R, to allow the clip to be positively located at any desired vertical height position. From this description, it will be appreciated that the clip 200 is, accordingly, height adjustable.

The clip 200 is specifically designed to cooperate with an interior wire basket of a dishwasher. This may be achieved as follows.

Wire baskets or racks within a dishwasher are generally of an open lattice type formation, generally having vertical and horizontally running members. With the clip 200 at a desired height, the delivery cartridge 100 with which the mounting device is associated, may be positioned conveniently toward a side portion (preferably a corner) of the top rack of a dishwasher. The retaining fingers 210a, 210b, each have a reflex portion at their free end that is curved away from a main body part 220 of the clip 200, so as to allow easy admission of one of the horizontal members into a jaw area formed by the reflexed portion 215a, 215b of the retaining fingers 210a, 210b and a stem portion 225a, 225b of biasing means 230a, 230b. Here, it will be noted that the biasing means 230a, 230b comprise arms which extend from the body portion 220 of the clip, adjacent to an area where the detent means 240 is formed. The biasing means 230a, 230b extend intermediate the retaining fingers 210a, 210b and the delivery cartridge 100 and are arranged such that once the horizontal member of the dishwasher rack/wire basket has been introduced behind the reflexed portions 215a, 215b of the retaining fingers 210a, 210b, the horizontal member is urgeable into a holding position in which it is trapped between the free ends of the biasing means 230a, 230b and an inner surface of the retaining fingers 210a, 210b.

The biasing means 230a, 230b each, at free end portions 228 have a profile, as shown best by the views of the clip variation shown in FIGS. 9(a) and 9(b), which incorporates a ramped area r, which is arranged to guide the horizontal member along its ramped surface and also have a retaining area S, in which an appropriate horizontal member of the dishwasher rack is arranged to securely sit. This retaining area S, may be formed so as to resist movement of the horizontal member away from it. For instance, the area S may have an upwardly projecting jaw or other means, to ensure positive location of the horizontal member within it. Also, the biasing means 230a, 230b, are resiliently biased toward the inner surface of the retaining fingers 210a, 210b such that as the horizontal member is introduced into the retaining area of the biasing means 230a, 230b, they flex first inwardly, toward the delivery cartridge and then, once the horizontal member is sitting correctly within the retaining areas S, they spring back outwardly so as to securely cradle the horizontal member between biasing means 230a, 230b and retaining fingers 210a, 210b.

From a user point of view, all that is required is to select an appropriate place on the upper rack to position the delivery cartridge, introduce one of the horizontal members into the jaw region formed between the reflex portion 215a, 215b and stem portions 225a, 225b of the clip 200 and push downwardly on the delivery cartridge, until the base of the delivery cartridge 100 is sitting securely on the base of the wire rack. As the cartridge is pushed downwardly, the horizontal member will automatically introduce itself into the correct retaining position between the biasing fingers and retaining fingers and the mounting clip 200 will move to the appropriate position on the slider mechanism 300. The positive detent mechanism formed between the detent means 240 and ridges R, and the positive location of the horizontal member with regard to the clip 200 will both help to prevent any further inadvertent movement of the delivery cartridge in use. Also, even if the base of the delivery cartridge 100 does not make full contact with a base area of the dishwasher rack/basket, the positioning of the clip 200 to the side of the wire basket, will ensure that the normal hanging position of the delivery cartridge 100 should be approximately vertical, since, for instance, some part of the lower receptacle 110 will naturally lean against one or other extra horizontal members of the dishwasher basket/rack.

An important point of note is that the mounting clip 200 features a pair of retaining fingers 210a, 210b having a vertical gap formed between them. By virtue of this vertical gap, extra freedom of placement of a delivery cartridge within a dishwasher machine is provided. This gap between the two retaining fingers 210a, 210b allows the delivery cartridge to be mounted at points on a wire dishwasher rack where vertical and horizontal members cross one another. This means that the device need not be mounted on the top horizontal member of a dishwashing rack, but may be mounted at any suitable point. Indeed, the crossing nature of the vertical and horizontal wires may actually add stability to the delivery cartridge when in use as, the central vertical wire running between the space between the two retaining fingers will help to minimise chances of the delivery cartridge being knocked out of the vertical (perpendicular) position.

Accordingly, there has been described above a convenient mounting device for a delivery cartridge for use within dishwasher machines, in which easy mounting of the delivery cartridge is facilitated, and positive location of the delivery cartridge within an interior part of the machine dishwasher is assured.

Referring now to FIGS. 10 through 13, there is shown another possible embodiment of mounting device in accordance with the present invention. Here, equivalent members are designated by equivalent numbering so as to facilitate the understanding of the reader, and to avoid redundancy in description. It will be noted that the slider mechanism 300 as shown in FIG. 10 forms part of the lower receptacle 110 and extends above an upper part of the lower receptacle 110. This slider mechanism 300 may be formed integrally as a single moulding with the lower receptacle 110. The slider mechanism 300 further incorporates an end stop 300s, at its upper extent, so as to limit movement of the mounting clip 200.

It will also be seen that instead of the biasing means 230a, 230b being formed from the same plastics moulding as the main part of the clip 200, here they may be formed of, for instance, one or more pieces of spring steel. For instance, the formation of the biasing means 230a, 230b may be from a C-shaped piece of spring steel material, the arms of the C forming the biasing means 230a, 230b themselves, whilst the stem joining the two arms of the C may sit within an appropriate locating lug (not shown) formed on the mounting clip 200. Alternatively, the biasing means 230a, 230b may be from individual spring steel members located in any convenient manner to a main body 220 of the clip 200.

Here, it will be noted that rather than the biasing means 230a, 230b having a separate ramp section r, and retaining section S, the biasing arms are simply formed of a straight section of spring steel positively biased against hooked portions of retaining fingers 210a, 210b. The hook portions are provided in place of the reflex portions of the first embodiment and allow easy introduction of a horizontal member of the retaining basket of a machine dishwasher to be introduced between them and the biasing means and, these hook portions themselves then retain that horizontal member as it is squeezed between the biasing means 230a, 230b and the hooked region.

In all other important respects, the mounting clip of FIGS. 10 to 13, is identical in action to the mounting clip of the embodiment of FIGS. 1 to 9.

Another variation to the mounting device of the second embodiment is shown in FIGS. 14 and 15. Here, it can be seen that the mounting device of FIG. 14 has been simplified somewhat, in that the retaining arms 210a, 210b are of a simple curved hook formation, whilst the biasing means r (as can best be seen from the exploded view of FIG. 15) formed of individual sprung steel pieces, having a location arm 232a, 232b which serves to locate them upon the main body 220 of the clip. In other respects, the embodiment of FIGS. 14 and 15 is similar to the embodiment of FIGS. 10 to 13, and functions in the same fashion. Here, note that the ridged base of the slider mechanism 230, whilst not shown, has simply been omitted from the pictures for clarity. In actual embodiments of the arrangements of FIGS. 14 and 15, this ridged base forming the slider mechanism 230 is present.

It will be appreciated by the skilled reader that numerous variations may be made to the design of the clip without departing from the teachings of the present invention. For instance, features of the second embodiment may be combined with features of the first embodiment and vice versa. Also, where specific detent means are shown, they may be substituted by equivalent detent means and, where a pair of retaining arms, or biasing means are shown, it will be appreciated that these may be substituted by a single retaining means and biasing means, or indeed by any plurality of any such objects. Other variations will also be apparent to the skilled man.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A mounting device comprising a mounting clip and a slider mechanism whereby the slider mechanism forms part of a detergent delivery cartridge and the mounting clip is positively locatable into one of a plurality of locations along said slider mechanism to provide a height adjustable mounting for attaching a detergent delivery cartridge to an interior part of a machine dishwasher.

2. The mounting device according to claim 1, wherein said slider mechanism extends substantially vertically and is formed to one vertical side of the detergent delivery cartridge.

3. The mounting device according to claim 1, wherein the mounting clip is arranged to positively locate the detergent delivery cartridge to a rack or basket of a machine dishwasher.

4. The mounting device according to claim 1 wherein the slider mechanism comprises a linearly extending ratchet base, having a plurality of detent positions defined by a plurality of ridges formed at regularly spaced intervals along at least part of its length.

5. The mounting device according to claim 4, wherein the slider mechanism includes at least one vertically extending guide portion for guiding movement of the mounting clip thereon.

6. The mounting device according to claim 5, wherein the mounting clip includes guide means for cooperation with said at least one guide portion of the slider mechanism.

7. The mounting device according to claim 4, wherein the mounting clip comprises detent means for cooperation with the ridges R of said slider mechanism to enable said mounting clip to be positively located in one of a plurality of possible mounting positions along said slider mechanism.

8. The mounting device according to claim 1 wherein the mounting clip comprises retaining means for positively locating the mounting clip to the interior part of the dishwasher.

9. The mounting device according to claim 8, wherein said retaining means comprises at least one retaining finger depending outwardly from a body portion of the mounting clip and arranged for positive association with said interior part of said dishwasher.

10. The mounting device according to claim 9, wherein said retaining means comprises at least two retaining fingers and, said retaining fingers are spaced apart from one another in the horizontal direction, so as to allow a vertical member of a dishwasher rack to run between them.

11. The mounting device according to claim 9, wherein said mounting clip further comprises biasing means for providing said positive association.

12. The mounting device according to claim 11, wherein said biasing means and said retaining means are arranged to grip said interior part between them.

13. The mounting device according to claim 9, wherein said at least one retaining finger comprises a reflex portion curved away from a main body part of the mounting clip so as to allow admission of said interior part.

14. The mounting device according to claim 13, wherein said reflexed portion and said biasing means between them form a jaw area, into a widest part of which the interior part is introducible and progressively moveable into a constricted area.

15. The mounting device according to claim 14, wherein said interior part of the machine dishwasher is positively gripped between said biasing means and retaining means in the constricted area defined between said retaining means and biasing means.

16. The mounting device according to claim 13, wherein said biasing means comprises at least one arm extending from a body portion of the mounting clip.

17. The mounting device according to claim 16, wherein the biasing means extends intermediate said at least one retaining finger and said slider mechanism.

18. The mounting device according to claim 17, wherein said biasing means includes a ramped area r which is arranged to guide said interior part along its ramped surface.

19. The mounting device according to claim 18, wherein said biasing means includes a retaining area against which, in use, said interior part is arranged to abut.

20. The mounting device according to claim 1 wherein said mounting clip is formed from a single plastics moulding.

21. A delivery cartridge adapted to deliver dosages of detergent composition to a dishwasher, said cartridge including a mounting device according to claim 1.

22. (canceled)

23. (canceled)

24. The mounting device according to claim 11, wherein said biasing means comprises a metal clip.

25. The mounting device according to claim 24, wherein said biasing means comprises at least one biasing arm.

26. The mounting device according to claim 24, wherein said metal clip comprises a C-shaped metal clip, wherein the arms of said C-shape perform a biasing function, whilst a stem portion of said C-shape forms a locating part for cooperation with a main body portion of the mounting clip.

27. The mounting device according to claim 25, wherein said arm or arms is/are positively biased toward an interior surface of the retaining means.

28. The mounting device according to claim 24 wherein said retaining means comprises at least one retaining finger including a hook portion, wherein said hook is directed toward a main body portion of said mounting clip.

29. The mounting device according to claim 28, wherein said biasing means is arranged to clamp said interior part between the biasing means and said hook portion.

30. A delivery cartridge including a mounting device according to claim 24.

31. (canceled)

32. (canceled)
